(19) United States
(12) Patent Application Publication
(10) Pub. No.: US 2022/0383127 A1
(43) Pub. Date: Dec. 1, 2022

(54) METHODS AND SYSTEMS FOR TRAINING A GRAPH NEURAL NETWORK USING SUPERVISED CONTRASTIVE LEARNING

(71) Applicants: Basmah ALTAF, Burnaby (CA); Yingxue ZHANG, Montreal (CA)

(72) Inventors: Basmah ALTAF, Burnaby (CA); Yingxue ZHANG, Montreal (CA)

(21) Appl. No.: 17/335,904

(22) Filed: Jun. 1, 2021

(51) Int. Cl. G06N 3/08

(52) U.S. Cl. CPC G06N 3/084

(57) ABSTRACT

Methods and systems are described for training a graph neural network (GNN) to perform a node classification task. A GNN is first pre-trained using ground-truth labeled nodes. The GNN is then used to predict labels for a set of unlabeled nodes, and the predicted labels having confidence indicators that satisfy a high confidence criterion are selected as pseudo labels that are assigned to corresponding nodes. The pseudo labeled nodes and ground-truth labeled nodes are combined together into a combined set of labeled nodes. Using the combined set of labeled nodes, the GNN is trained by computing a total loss between predicted labels generated by the GNN and assigned labels in the combined set of labeled nodes, the total loss being computed as a sum of a computed cross-entropy loss and a computed supervised contrastive loss.

### FIELD

The present disclosure relates to methods and systems for training a graph neural network, including methods and systems for training a graph neural network, using supervised contrastive learning, to perform a node classification task.

### BACKGROUND

A graph is a data structure which represents a set of entities (e.g., real-world objects or people) as nodes, and the relationships between the nodes as edges connecting the nodes. Together, the nodes and edges form the graph. Features of a node are represented as respective values in a feature vector of the node. A graph can be a useful data structure that is applicable to a variety of real-life applications such as modelling physical systems, identifying molecular fingerprints, identifying protein-protein interactions, generating recommendations, representing knowledge graphs, and controlling traffic networks, among other possibilities.

A graph neural network (GNN) is a type of neural network which receives an adjacency matrix and a feature matrix of a graph as input. The adjacency matrix is formed based on the structural connectivity of the nodes of the graph, and the feature matrix is formed by the feature vectors of the respective nodes of the graph. A trained GNN models an encoder function which encodes the features of each node of the input graph into a respective low-dimensional vector (referred to as an embedding). A satisfactorily trained GNN should encode the features of nodes into embeddings such that nodes having features similar to each other are encoded as embeddings that are in close proximity in the embedding space (i.e., the vector space defined by all possible embeddings). The GNN further processes the embeddings (e.g., using a final output layer of the GNN, such as a final softmax layer) to generate a predicted output, such as a predicted label representing a predicted node class. Each predicted node class is a class from a defined set of classes, which may depend on the particular application. For example, for a movie recommendation application, nodes may represent humans and the possible node classes may represent movie genres of interest. Node classification (i.e., predicting the label of a node that was unlabeled in the input data) is a common inference task to be performed by a trained GNN.

Contrastive learning is a machine learning technique that is commonly used to train a neural network. Conceptually, contrastive learning trains the neural network to distinguish between data points that are similar or different. A challenge for training a GNN using contrastive learning is that there is typically a scarcity of graphs having ground-truth labels (i.e., graphs having nodes assigned with ground-truth labels representing the ground-truth classes of the nodes) that can be used as training data. As a result, existing contrastive learning techniques for training a GNN typically are self-supervised contrastive learning techniques in which a GNN is trained using unlabeled nodes, where each node is considered its own class. The GNN is thus trained to distinguish between individual nodes, rather than between node classes. A GNN that is trained in this way requires further fine-tuning (i.e., further training) to enable the GNN to accurately perform a node classification.

There is therefore a need for a solution that can more efficiently and more effectively train a GNN to perform a node classification task.

### SUMMARY

In various examples, the present disclosure describes methods and systems for training a GNN to perform a node classification task, using supervised contrastive learning. Existing contrastive learning techniques for training a GNN use a self-supervised approach in which nodes are treated as unlabeled data. The disclosed methods and systems use a supervised contrastive learning approach, in which the GNN is trained using training data that includes a set of labels that are assigned to nodes in the training data (e.g. a training graph), where the set of labels includes ground-truth labels and pseudo labels assigned to nodes in the training data. This enables the GNN to be trained in a one-step, end-to-end fashion to perform the node classification task, without requiring further fine-tuning to tailor the trained GNN to perform a node classification task.

The present disclosure describes methods and systems for training the

GNN in which, in each training iteration, labels that are predicted for the unlabeled nodes (i.e. nodes that are not assigned a ground label) with high confidence by the GNN are used as pseudo labels for the unlabeled nodes. Pseudo labels may be assigned to the unlabeled nodes and the pseudo labels may be added to the set of ground-truth labels in the training data (e.g. the training graph), thus increasing the amount of labeled nodes in the training data that can be used to train a GNN.

In some examples of the present disclosure, a technique for selecting negative nodes for construction of data triplets (comprising an anchor node, a positive node and a negative node, and used for computation of the supervised contrastive loss) is described. In examples of the present disclosure, negative nodes are selected based on the cross-community ratio, which is a metric based on the structural connectivity of nodes in the graph topology. In some examples hard negatives sampling technique is disclosed which may be used to construct data triplets that may enable more efficient training (e.g., requiring fewer iterations) of the GNN.

The disclosed methods and systems may be used for training of GNN for any node classification task. The present disclosure is not limited to any specific GNN architecture, and may be used for training various GNN architectures, such as graph convolutional network (GCN), graph attention network (GAT), GraphSAGE (e.g., as described by Hamilton et al. “Inductive Representation Learning on Large Graphs” arXiv:1706.02216, 2017), or GCNII (e.g., as described by Chen et al. “Simple and Deep Graph Convolutional Networks” Proceedings of the 37th International Conference on Machine Learning, PMLR 119: 1725-1735, 2020), among other possibilities.

In some example aspects, the present disclosure describes a method for training a graph neural network (GNN) to perform a node classification task. The method includes: obtaining a set of pre-trained values for parameters of the GNN; training the GNN by, in each training iteration: inputting an adjacency matrix and a feature matrix of a set of unlabeled nodes of a graph to the GNN to obtain a predicted label for each node in the set of unlabeled nodes; selecting one or more of the predicted labels as respective one or more pseudo labels, each predicted label that is selected as a pseudo label being associated with a confidence indicator that satisfies a high confidence criterion; assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and updating the values of the parameters of the GNN by: forward propagating an adjacency matrix and a feature matrix of the combined set of labeled nodes to generate, using the GNN, a predicted label for each node in the combined set of labeled nodes; computing a total loss between the predicted labels generated by the GNN for the combined set of labeled nodes and assigned labels of the combined set of labeled nodes, the total loss being computed as a sum of a computed cross-entropy loss and a computed supervised contrastive loss; and backpropagating a gradient of the computed total loss to update the values of the parameters of the GNN. The method also includes repeating the training iterations until a convergence condition is satisfied; and storing the updated values of the parameters of the GNN as learned values of the parameters of the GNN.

In the preceding example aspect of the method, the method may include: prior to computing the total loss, constructing data triplets for computing the supervised contrastive loss, each data triplet being constructed by: selecting a first node in the combined set of labeled nodes as an anchor node of the data triplet; selecting a second node in the combined set of labeled nodes as a positive node of the data triplet, the positive node and the anchor node having assigned labels representing a same class; and selecting a third node in the combined set of labeled nodes as a negative node of the data triplet, the negative node and the anchor node having assigned labels representing different classes. The supervised contrastive loss may be computed using the constructed data triplets.

In the preceding example aspect of the method, selecting the third node as the negative node may include: computing a cross-community ratio between a first community of nodes having assigned labels representing the same class as the anchor node and each other community of nodes in the combined set of labeled nodes; and selecting the third node as the negative node based on the third node belonging to a second community of nodes having a highest cross-community ratio with the first community of nodes.

In the preceding example aspect of the method, the cross-community ratio computed between the third node and the anchor node may represent a strength of cross-community connectivity between the first community of nodes and the second community of nodes.

In any of the preceding example aspects of the method, a predicted label that is selected as a pseudo label may be associated with a softmax probability that satisfies the high confidence criterion.

In any of the preceding example aspects of the method, obtaining the set of pre-trained parameters for the parameters of the GNN may include: training the GNN using the set of ground-truth labeled nodes and using computation of a cross-entropy loss.

In any of the preceding example aspects of the method, the method may include: storing the pseudo labels from a final training iteration as ground-truth labels of the graph.

In some example aspects, the present disclosure describes a computing system for training a graph neural network (GNN) to perform a node classification task. The computing system includes a processing unit and a memory storing instructions which, when executing by the processing unit, cause the computing system to: obtain a set of pre-trained values for parameters of the GNN; train the GNN by, in each training iteration: inputting an adjacency matrix and a feature matrix of a set of unlabeled nodes of a graph to the GNN to obtain a predicted label for each node in the set of unlabeled nodes; selecting one or more of the predicted labels as respective one or more pseudo labels, each predicted label that is selected as a pseudo label being associated with a confidence indicator that satisfies a high confidence criterion; assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and updating the values of the parameters of the GNN by: forward propagating an adjacency matrix and a feature matrix of the combined set of labeled nodes to generate, using the GNN, a predicted label for each node in the combined set of labeled nodes; computing a total loss between the predicted labels generated by the GNN for the combined set of labeled nodes and assigned labels of the combined set of labeled nodes, the total loss being computed as a sum of a computed cross-entropy loss and a computed supervised contrastive loss; and backpropagating a gradient of the computed total loss to update the values of the parameters of the GNN. The instructions further cause the computing system to: repeat the training iterations until a convergence condition is satisfied; and store the updated values of the parameters of the GNN as learned values of the parameters of the GNN.

In the preceding example aspect of the computing system, the instructions may further cause the computing system to: prior to computing the total loss, construct data triplets for computing the supervised contrastive loss, each data triplet being constructed by: selecting a first node in the combined set of labeled nodes as an anchor node of the data triplet; selecting a second node in the combined set of labeled nodes as a positive node of the data triplet, the positive node and the anchor node having assigned labels representing a same class; and selecting a third node in the combined set of labeled nodes as a negative node of the data triplet, the negative node and the anchor node having assigned labels representing different classes. The supervised contrastive loss may be computed using the constructed data triplets.

In the preceding example aspect of the computing system, the instructions may cause the computing system to select the third node as the negative node by: computing a cross-community ratio between a first community of nodes having assigned labels representing the same class as the anchor node and each other community of nodes in the combined set of labeled nodes; and selecting the third node as the negative node based on the third node belonging to a second community of nodes having a highest cross-community ratio with the first community of nodes.

In the preceding example aspect of the computing system, the cross-community ratio computed between the third node and the anchor node may represent a strength of cross-community connectivity between the first community of nodes and the second community of nodes.

In any of the preceding example aspects of the computing system, a predicted label that is selected as a pseudo label may be associated with a softmax probability that satisfies the high confidence criterion.

In any of the preceding example aspects of the computing system, the instructions may further cause the computing system to obtain the set of pre-trained values for the parameters of the GNN by: training the GNN using the set of ground-truth labeled nodes and using computation of a cross-entropy loss.

In any of the preceding example aspects of the computing system, the instructions may further cause the computing system to: store the pseudo labels from a final training iteration as ground-truth labels of the graph.

In some example aspects, the present disclosure describes a non-transitory computer readable medium for training a graph neural network (GNN) to perform a node classification task, the non-transitory computer readable medium having instructions encoded thereon. The instructions, when executed by a processing unit of a computing system, cause the computing system to: obtain a set of pre-trained values for parameters of the GNN; train the GNN by, in each training iteration: inputting an adjacency matrix and a feature matrix of a set of unlabeled nodes of a graph to the GNN to obtain a predicted label for each node in the set of unlabeled nodes; selecting one or more of the predicted labels as respective one or more pseudo labels, each predicted label that is selected as a pseudo label being associated with a confidence indicator that satisfies a high confidence criterion; assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and updating the values of the parameters of the GNN by: forward propagating an adjacency matrix and a feature matrix of the combined set of labeled nodes to generate, using the GNN, a predicted label for each node in the combined set of labeled nodes; computing a total loss between the predicted labels generated by the GNN for the combined set of labeled nodes and assigned labels of the combined set of labeled nodes, the total loss being computed as a sum of a computed cross-entropy loss and a computed supervised contrastive loss; and backpropagating a gradient of the computed total loss to update the values of the parameters of the GNN. The instructions further cause the computing system to: repeat the training iterations until a convergence condition is satisfied; and store the updated values of the parameters of the GNN as learned values of the parameters of the GNN.

In the preceding example aspect of the computer readable medium, the computer readable medium may further include instructions to cause the computing system to perform any of the example aspects of the methods described above.

### BRIEF DESCRIPTION OF THE DRAWINGS

Reference will now be made, by way of example, to the accompanying drawings which show example embodiments of the present application, and in which:

FIG. 1 is a block diagram illustrating an example dataflow for training a GNN, in accordance with examples of the present disclosure;

FIG. 2 is a flowchart illustrating a method for training a GNN, in accordance with examples of the present disclosure;

FIG. 3 is a diagram of a simplified graph, illustrating inner-community edges and cross-community edges; and

FIG. 4 is a block diagram of an example computing system, on which examples of the present disclosure may be implemented.

Similar reference numerals may have been used in different figures to denote similar components.

### DESCRIPTION OF EXAMPLE EMBODIMENTS

To assist in understanding the present disclosure, some terminology is first discussed. A graph is a data structure which may be defined as a set of nodes (denoted as V, with individual nodes being denoted as v) connected by a set of edges (denoted as E, with individual edges being denoted as e). The edge between two given nodes represents the relationship between the two nodes. For example, if the nodes of a graph represents cities, then the edges may represent roads connecting the cities. In another example, if the nodes of a graph represent individuals, then the edges may represent social connectivity between the individuals. In some examples, the nodes of a graph may represent different types of entities (e.g., some nodes may represent individuals, and other nodes of the same graph may represent items available for purchase). A graph may be denoted as G, such that G=(V, E). The features of the i-th node vᵢ may be represented by a feature vector denoted as xᵢ, and the class of the node vᵢ may be represented by a label denoted as yᵢ. A feature matrix (denoted as X) of the graph is formed by concatenating all the feature vectors x of all the nodes (where the i-th row of the feature matrix X corresponds to the feature vector xᵢ of the i-th node vᵢ). The structural connectivity of the graph may be represented by an adjacency matrix (denoted as A). The adjacency matrix A is a square matrix of size n×n, where n is the number of vertices in the set of nodes V. An entry in the adjacency matrix A, denoted as aᵢⱼ, is 1 if there is an edge from the i-th vertex to the j-th vertex, and 0 otherwise.

A graph neural network (GNN) is neural network which accepts the adjacency matrix and feature matrix of a graph as input and generates a predicted output. Typically, inner layers (also referred to as hidden layers) of the GNN model an encoder function to encode the features of each node of the graph into a respective embedding. An embedding (also referred to as a node embedding or node representation) that represents the features of a node v, denoted as hᵥ, is a vector (typically a low-dimensional vector having a dimensionality lower than the dimensionality of the feature vector). The vector space defined by all possible embeddings is referred to as the embedding space. A final output layer of the GNN typically applies a non-linear activation function (e.g., a softmax function, a sigmoid function, a rectified linear unit (ReLU) function, or a tanh function) to each embedding to generate the predicted output. For example, if the GNN is designed to perform a node classification task, the final output layer may apply a softmax function to an embedding (encoded from a given node), and output the predicted label for that given node. A goal of training the GNN is to learn values for the parameters (e.g., weights) in each layer such that nodes having similar features are encoded into embeddings that are in close proximity to each other in the embedding space, so that a prediction can be generated with high accuracy.

In general, a neural network (including a GNN) may be trained to perform a classification task using training data (also referred to as training samples or examples) that may or may not be labeled with ground-truth labels (i.e. assigned a ground-truth label). A loss function is a metric that is designed to measure the performance of the neural network at a certain prediction task by comparing predicted labels generated by the neural network with ground-truth labels of the training data. During training, the values of the parameters of the neural network are adjusted, with the goal of reducing the loss. Training is performed over a plurality of iterations, until a convergence condition is met (e.g., the loss converges, or a maximum number of iterations is reached).

Backpropagation is a typical optimization algorithm by which the values of the parameters (e.g., weights) of the neural network are updated in each iteration. In backpropagation, a gradient-descent algorithm is used that computes the gradient of the loss function with respect to the parameters, and adjusts the values of the parameters in small steps in the opposite direction of the gradient. The aim is to gradually decrease the loss until the loss converges to some local minima. In the context of a GNN, the following equation represents how the values of the parameters are updated in each iteration:

W^{(t+1)}=W^{(t)}−η∇ [symbol] (f_{θ}(xᵢ), yᵢ)

where W is the set of trainable values for the parameters (e.g., weights and biases) of the GNN, t is the count of the current training iteration, [symbol] is the loss function, xᵢ is the feature vector for input node vᵢ, yᵢ is the ground-truth label of node vᵢ, f_{θ}(xᵢ) is the prediction generated by the GNN, and η is a hyperparameter (typically set to a small value, such as 0.01) that controls the amount by which the values of the parameters are updated in each training iteration (also referred to as the learning rate).

A neural network may be trained using unsupervised learning (also referred to as unsupervised training) or supervised learning (also referred to as supervised training). In unsupervised learning, the neural network is trained using unlabeled data (i.e., data without ground-truth labels). In supervised learning, a neural network is trained using labeled data (i.e., data that have been assigned ground-truth labels).

In a node classification task, a trained GNN is used to predict the label of an unlabeled node in a graph. A typical approach to train a GNN to perform a node classification task is to train the GNN in a supervised manner, using a negative log-likelihood loss (also known as cross-entropy loss). Other methods of computing the loss in supervised learning may be used. A drawback of conventional supervised learning techniques is that a large training dataset (e.g., having 10,000 training data samples or more) is typically required to train a neural network to a desired level of performance (e.g., to achieve a desired prediction accuracy). For training a GNN, obtaining such a large training dataset of labeled nodes is typically difficult (compared to availability of labeled data in other domains such as image, text and audio data). Accordingly, existing techniques for training a GNN typically rely on unsupervised learning.

Self-supervised learning is a form of unsupervised learning, in which a neural network supervises its own learning. Typically the neural network is first trained to perform an auxiliary task (without using labeled training data), which enables the neural network to learn to generate predictions that are useful for the auxiliary task. The neural network may be fine-tuned (i.e., further trained) for the primary task.

Self-supervised contrastive learning is another form of unsupervised learning, which is used in some existing techniques for training a GNN. In self-supervised contrastive learning, augmented (i.e., having some modification or transformation applied) data samples are generated from original data samples (also referred to as anchor data points). The neural network is then trained to perform a prediction task to predict whether two augmented samples are from the same original data sample or not. Conceptually, the neural network is trained to distinguish whether two data points are similar or different. More formally, for a given data point x, the neural network is trained to model an encoder function f such that:

score(f(x), f(x⁺))>>score(f(x), f(x⁻))

where x is an anchor data point, x⁺ (referred to as a positive sample) is a data point that is similar to x, x⁻ (referred as negative sample) is a data point dissimilar to x, and score is a similarity metric used to compute the similarity between any two embeddings. Contrastive learning is based on a data triplet, where the data triplet consists of an anchor data point, a positive sample and a negative sample.

In the context of self-supervised contrastive learning to train a GNN, the anchor data point is an anchor node, the augmented version of the anchor node is a positive node, and the other nodes in the graph are negative nodes. Augmentation of an anchor node may be performed using basic graph alteration operations including edge deletion from the anchor node neighborhood, or masking out anchor node features. The drawback of self-supervised contrastive learning is that the GNN only learns to distinguish each individual node (i.e., each node is considered its own class), and further fine-tuning (i.e., further training) is required to train the GNN to learn the boundary between embeddings of different classes in the embedding space, to enable the GNN to perform a node classification task.

In the present disclosure, methods and systems are described for training a GNN using supervised contrastive learning. The GNN is trained end-to-end for a node classification task, and further fine-tuning is not required.

To help improve the efficiency of the disclosed methods and systems for training a GNN, the present disclosure further describes a technique for constructing a data triplet to be used for supervised contrastive learning, in which the negative node is a “hard negative” node. This means that, in the data triplet, the similarity between the anchor node and the positive node is equal to or less than the similarity between the anchor node and the negative node. In some examples, the GNN may be trained using data triplets constructed using hard negatives sampling, which may result in the GNN learning to generate embeddings that encode more useful features for distinguishing between classes.

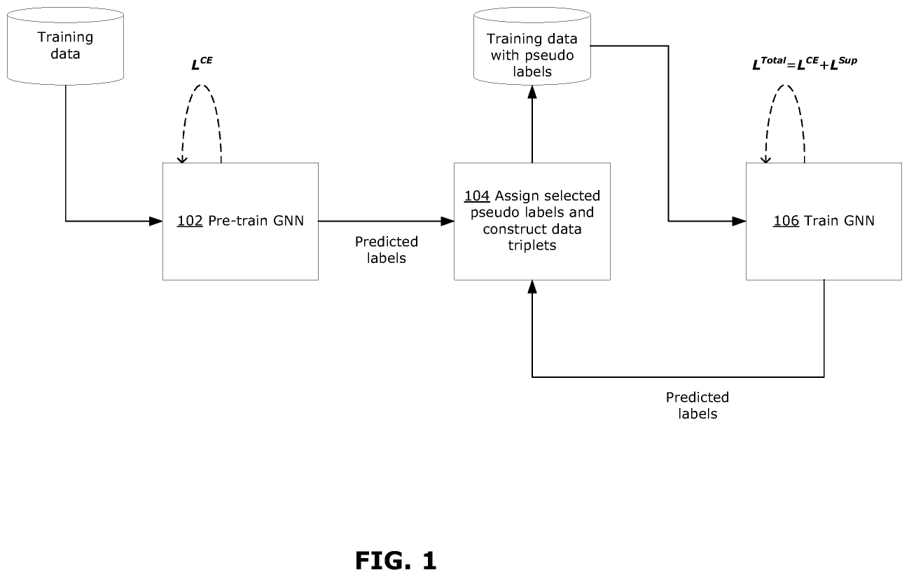

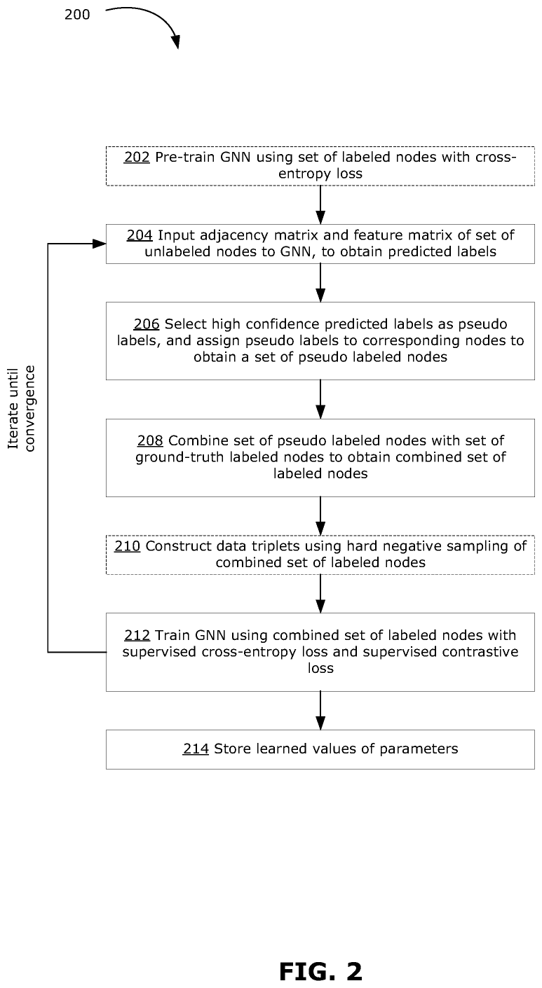

FIG. 1 is a diagram illustrating an example dataflow for training a GNN, in accordance with examples of the present disclosure. FIG. 1 provides an overview of an example method for training the GNN, details of which will be further discussed with reference to FIG. 2. The GNN may be, for example, a graph convolutional network (GCN), or a GNN having any other suitable network architecture.

The GNN is trained using training data. For training a GNN, training data comprises nodes of a graph. In this example, the training data is a graph G comprising N nodes. The N nodes includes a set of unlabeled nodes (also referred to as the unlabeled set), denoted as Gᵤ, and a set of labeled nodes (also referred to as the labeled set), denoted as Gₗ. Each node in the labeled set Gₗ is assigned a respective ground-truth label, and the labeled set Gₗ may be defined as follows:

Gₗ={xᵢ, yᵢ}ᵢ₌₁^{N}^{ₗ}

where xᵢ is the feature vector of the i-th node vᵢ, yᵢ is the ground-truth label assigned to the i-th node vᵢ, and Nₗ is the number of labeled nodes in the graph G.

The unlabeled set Gᵤ may be similarly defined, with the difference that there is no ground-truth label assigned to the nodes. The unlabeled set Gᵤ may be defined as follows:

Gᵤ={xᵢ}ᵢ₌₁^{N}^{ᵤ}

where Nᵤ is the number of unlabeled nodes in the graph G.

At the first block 102, the GNN is pre-trained using only the labeled set Gₗ. The pre-training is performed using a supervised learning algorithm. For example, in each pre-training iteration, the adjacency matrix and feature matrix of the labeled set Gₗ is forward propagated through the GNN to generate a predicted label (denoted as ŷᵢ) for each node vᵢ in the labeled set Gₗ. A cross-entropy loss (denoted as L^{CE}) may then be computed between the predicted labels ŷᵢ and the ground-truth labels yᵢ. A generalized equation for computing the cross-entropy loss LC^{E} is as follows:

$${L}^{C E} = - {\sum }_{i ∈ V} {\sum }_{j = 1}^{L} {Y}_{ij} log ( {\hat{Y}}_{ij} )$$

where V is the set of nodes in the labeled training data, the inner summation is summed over the number (L) of unique class labels for the set of nodes and is the sum individual loss for each node (i∈V), and the outer summation is summed over all nodes in V. The computed cross-entropy loss L^{CE} is used to update the values of the parameters of the GNN, using a backpropagation algorithm (indicated using a dashed curved arrow in FIG. 1).

After the GNN has been suitably pre-trained using the labeled set Gₗ (e.g., the cross-entropy loss L^{CE} has converged), the adjacency matrix and feature matrix of the unlabeled set Gᵤ is inputted to the pre-trained GNN. The output from the pre-trained GNN is a set of predicted labels (i.e., one predicted label ŷᵢ for each node vᵢ in the unlabeled set Gᵤ). The values of the parameters learned from pre-training are used to initialize the parameters of the GNN for further training of the GNN.

The predicted labels ŷᵢ are used, at the second block 104, to select one or more of the predicted labels ŷᵢ as one or more pseudo labels to be assigned to respective one or more nodes vᵢ in the unlabeled set Gᵤ. The term “pseudo label” means that the label is a predicted label that has a high probability of being accurate (i.e., a high probability of representing the correct class for the corresponding node). However, a pseudo label may be inaccurate (i.e., a pseudo label is not a ground-truth label). Selection of one or more predicted labels ŷᵢ to be used as pseudo labels is based on the level of confidence associated with each predicted label ŷᵢ. For example, if each predicted label ŷᵢ is generated by applying a softmax function (e.g., in a final softmax layer of the GNN) to the respective embedding zᵢ generated by the layer of the GNN subsequent to the final softmax layer of the GNN, then the softmax probability represents the level of confidence of the predicted label ŷᵢ (where a higher value for the softmax probability represents a higher confidence that the predicted label ŷᵢ is accurate).

The pseudo labels are assigned to the corresponding nodes, and the set of nodes that have been assigned pseudo labels may be referred to as the set of pseudo labeled nodes or the pseudo labeled set, denoted as Gₗ′. The labeled set Gₗ is then combined (i.e., concatenated) with the pseudo labeled set Gₗ′.

At the second block 104, data triplets are also constructed, which will be used to compute a supervised contrastive loss. Unlike the data triplets used for self-supervised contrastive learning, the data triplets used for supervised contrastive learning are constructed based on the labels (either the ground-truth label or the pseudo label) assigned to each node. A data triplet consists of an anchor node, a positive node (i.e., a node having the same label as the anchor node) and a negative node (i.e., a node having a different label than the anchor node). In particular, each data triplet may be constructed using hard negatives sampling, as discussed further below.

At a third block 106, the GNN is trained using the training data with nodes of the graph that are assigned pseudo labels. In each training iteration, the values of the parameters (e.g., weights) of the GNN are updated. In a first iteration of the training, the GNN is initialized with the values of the parameters learned from the pre-training performed in the first block 102. In particular, training of the GNN performed is using a supervised learning algorithm, using the combined labeled set Gₗ and pseudo labeled set Gₗ′ as labeled training data. The training of the GNN involves computation of a supervised contrastive loss (denoted as L^{Sup}) using the constructed data triplets, in addition to the cross-entropy loss L^{CE}. A total loss (denoted as L^{Tot}) is computed as the sum of the L^{CE} and the supervised contrastive loss L^{Sup}. As indicated using a dashed curved arrow in FIG. 1, the total loss L^{Tot} is used to update the values of the parameters of the GNN using a backpropagation algorithm. A generalized equation for computing the total loss L^{Tot} is as follows:

$${L}^{T o t} = - ( {\sum }_{i ∈ V} {\sum }_{j = 1}^{L} {Y}_{ij} log ( {\hat{Y}}_{ij} ) + {\sum }_{i ∈ I} \frac{- 1}{\vert P ( i ) \vert} {\sum }_{p ∈ P ( i )} log \frac{exp ( {z}_{i} \cdot {z}_{p} / τ )}{{\sum }_{a ∈ A ( i )} exp ( {z}_{i} \cdot {z}_{a} / τ )} )$$

where the first term is the cross-entropy loss L^{CE}, and the second term is the supervised contrastive loss L^{Sup}. In the supervised contrastive loss L^{Sup} term, i is the index of the anchor node, P(i) is the set of all positive nodes (i.e., nodes that have same label as anchor node), A(i) is the set of all non-anchor nodes (including all positive nodes and all negative nodes with respect to anchor node, where a negative node is any node having a different label than the anchor node), and τ is the temperature parameter. When the supervised contrastive loss L^{Sup} is computed using the constructed data triplets, a negative node is any node that has been selected as a hard negative node of a data triplet. In that case, instead of summing over all non-anchor nodes A(i) in the denominator, the denominator term is instead:

$${\sum }_{a ∈ \{ P ( i ) , N ( i ) \}} exp ( {z}_{i} \cdot {z}_{a} / τ )$$

where N(i) is the set of all hard negative nodes that have been selected to be part of a data triplet.

A single iteration is considered complete after the GNN has been trained using the labeled set Gₗ and the pseudo labeled set Gₗ′ (e.g., a single pass has been made through all the nodes of the labeled set Gₗ and the pseudo labeled set Gₗ′, and the values of the parameters of the GNN have been updated by backpropagating the gradient of the computed total loss L^{Tot}). Another iteration may begin by forward propagating the adjacency matrix and feature matrix of the unlabeled set Gᵤ through the GNN. It should be noted that, at the start of the next iteration, the previously predicted pseudo labels may be discarded so that the nodes of the pseudo labeled set Gₗ′ are returned to the unlabeled set Gᵤ. The GNN generates a set of predicted labels ŷᵢ. The generated output is used again, at the second block 104 to assign high confidence predicted labels as pseudo labels (which may be different from the pseudo labels assigned in a previous iteration) and to construct data triplets. The training of the GNN is repeated (i.e., the dataflow loop with the second and third blocks 104, 106) until a convergence condition is satisfied (e.g., the values of the parameters of the GNN converge, the loss converges, a validation loss converges, a maximum number of training iterations has been performed, or some other accuracy metric is satisfied).

FIG. 2 is a flowchart illustrating an example method 200 for training a GNN. FIG. 2 illustrates detailed operations that may be used to implement the dataflow illustrated in FIG. 1. The method 200 (and the operations of the method 200) may be performed by a computing system (which may be referred to as the training system) to obtain a set of learned values for the parameters of the GNN. The GNN having the set of learned values for the parameters, may be referred to as the trained GNN. The trained GNN may be executed by the same or different computing system as the training system. For example, training of the GNN may be performed by a training system and execution of the trained GNN may be performed by a different computing system (which may be referred to as the execution system).

At operation 202, optionally, the GNN may be pre-trained using a set of labeled nodes. The GNN may have any architecture that is suitable for performing a node classification task. For example, the GNN may be a GCN, a GAT, GraphSAGE, or GCNII, among other possibilities. As previously described, the set of labeled nodes is a set of nodes that have been assigned ground-truth labels (i.e., labels representing the ground-truth class of each node). The GNN may be pre-trained by computing a cross-entropy loss between the predicted labels generated by the GNN and the ground-truth labels, and using a backpropagation algorithm to update the set of values for the parameters of the GNN based on the cross-entropy loss.

In some examples, pre-training of the GNN may be performed prior to the method 200. For example, the training system may retrieve a set of pre-trained values for the parameters of the GNN from an internal or external memory, and operation 202 may be omitted. Regardless of whether operation 202 is performed, the set of pre-trained values for the parameters of the GNN is obtained (e.g., by performing the pre-training at operation 202 or retrieved from a memory if operation 202 is omitted).

At operation 204, an adjacency matrix and feature matrix created from feature vectors associated with a set of unlabeled nodes (i.e., a set of nodes that have not been assigned a label) is inputted to the GNN. The set of unlabeled nodes are unlabeled nodes of a graph, which graph may also include a set of ground-truth labeled nodes. The adjacency matrix may be computed (using any suitable algorithm) from the edges defined in the set of unlabeled nodes. The feature matrix may be created by concatenating the feature vectors associated with the set of unlabeled nodes. The GNN outputs a set of predicted labels (i.e., a predicted label for each respective node in the set of unlabeled nodes).

At operation 206, one or more high confidence predicted labels are selected, from the outputted set of predicted labels, as pseudo labels. A predicted label that is selected as a pseudo label is selected on the basis that the confidence indicator associated with the predicted label satisfies a high confidence criterion. The confidence indicator may be the softmax probability (which is computed by the final softmax layer of the GNN) associated with each predicted label. Other confidence indicators may be used. In some examples, the high confidence criterion may be defined by a preset confidence threshold (e.g., the high confidence criterion may be a requirement that the softmax probability meets or exceeds a confidence threshold of 0.5, or a confidence threshold of 0.75). If a predicted label is associated with a softmax probability equal to or above the confidence threshold, then that predicted label is considered to be a high confidence predicted label that is selected as a pseudo label. In another example, the high confidence criterion may be defined by a preset percentage or number of predicted labels that has the highest softmax probability (or other confidence indicator). For example, the high confidence criterion may be a requirement that only the top 10% of predicted labels having the highest softmax probability are selected as pseudo labels. Each pseudo label is assigned to the corresponding node, and each node that is assigned a pseudo label is considered a pseudo labeled node. Any predicted label that is not a high confidence predicted label may be discarded, and the corresponding node remains an unlabeled node.

The selection of pseudo labels based on high softmax probability (or other confidence indicator) helps to ensure that the pseudo labeled nodes are more likely to be correctly labeled. However, it should be noted that not all pseudo labels may be correct, and in subsequent training iterations a different pseudo label (i.e., a pseudo label representing a different class) may be assigned to a given node. Over a number of iterations, the GNN is trained such that the GNN outputs predicted labels with higher confidence and more nodes may be assigned pseudo labels with higher confidence.

At operation 208, the set of pseudo labeled nodes are combined (i.e., concatenated) with the set of ground-truth labeled nodes (which may be the set of ground-truth labeled nodes used for pre-training the GNN at optional operation 202, or may be a different set of ground-truth labeled nodes). The resulting combined set of nodes may be referred to as the combined set of labeled nodes. By combining the set of pseudo labeled nodes with the set of ground-truth labeled nodes, a larger set of labeled nodes may be obtained for supervised training of the GNN. This approach may help to address the problem that there is typically a scarcity of ground-truth labeled nodes for training the GNN.

At operation 210, optionally, data triplets (i.e., the triplets comprising anchor node, positive node and negative node) may be constructed using hard negatives sampling of the combined set of labeled nodes. The selection of negatives used for supervised contrastive learning affect the efficiency of the learning (e.g., affecting the number of training iterations required for the parameter values of the GNN to converge). In each iteration of supervised contrastive learning, the GNN is penalized (i.e., a larger supervised contrastive loss is computed) if the embedding for the anchor node is mapped (in the embedding space) closer to the embedding for the negative node than to the embedding for the positive node, compared to the case where the embedding for the anchor node is mapped closer (in the embedding space) to that of the positive node. To train the GNN more efficiently, it would be useful for the data triplets to contain negative nodes that are close (in terms of proximity in the graph topology) to the anchor nodes, to train the GNN using data samples where the GNN is more likely to make erroneous predictions. Data triplets that are constructed using random sampling of the combined set of labeled nodes are unlikely to enable such efficient training.

The present disclosure describes a technique for construction of data triplets using hard negatives sampling. In the context of training a GNN, a hard negative node may be identified using the cross-community ratio. In a graph, the term community may be used to refer to a subset of nodes that are densely connected to each other. Generally, nodes belonging to the same community can be expected to belong to the same class. It should be noted that two communities may be in close proximity to each other or may even overlap. Inner-community ratio and cross-community ratio are two metrics that represent, respectively, the connectivity of nodes within the same community and the connectivity of nodes with different communities. The inner-community ratio is defined as the ratio of the number of edges connecting nodes belonging to a given community to other nodes within the same given community compared to the total number of all edges connecting the nodes of the given community (i.e., including edges connecting to nodes belonging to the same community as well as edges connecting to nodes belonging to different communities). The cross-community ration is defined as the number of edges connecting nodes belonging to a given community to nodes belonging to a different community compared to the total number of all edges connecting the nodes of the given community.

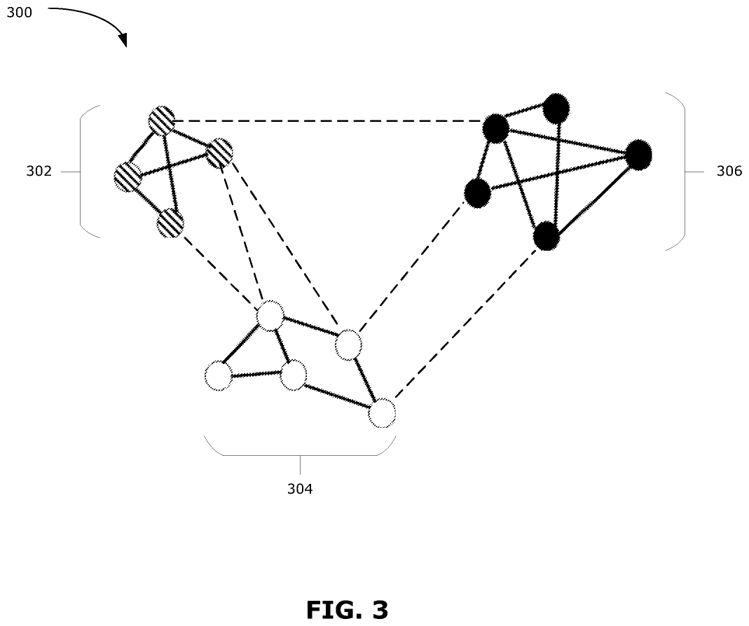

FIG. 3 shows a simplified graph, which may be used to illustrate the concepts of inner-community and cross-community ratios.

In FIG. 3, a graph 300 includes a first community of nodes 302 (i.e., a community of nodes having a first class label), a second community of nodes 304 (i.e., a community of nodes having a second class label) and a third community of nodes 306 (i.e., a community of nodes having a third class label) (also referred to simply as a first community 302, a second community 304 and a third community 306). The nodes belonging to each individual community 302, 304, 306 have the same label as other nodes of the same community 302, 304, 306. That is, nodes in the first community 302 are all labeled with (i.e. assigned) a first label (indicated by hatching), nodes in the second community 304 are all labeled with (i.e. assigned) a second label (indicated by white nodes), and nodes in the third community 306 are all labeled with (i.e. assigned) a third label (indicated by black nodes). The nodes in each community 302, 304, 306 have more inner-community edges (shown as solid lines) than cross-community edges (shown as dashed lines). Inner-community edges may also be referred to as intra-community or inner-community links or edges, and cross-community edges may also be referred to as inter-community or cross-community links or edges.

For the first community 302, there are five edges between the nodes in the same first community 302, three edges to nodes in the second community 304, and one edge to nodes in the third community 306. Thus, the inner-community ratio for the first community 302 is 5:9; the cross-community ratio between the first community 302 and the second community 304 is 3:9; and the cross-community ratio between the first community and the third community 306 is 1:9.

More generally, the inner-community and cross-community ratios for a graph may be computed using the cross-community strength matrix. For a given graph, the cross-community strength matrix (denoted as S) is defined as:

$$S = [ \begin{matrix}{β}_{1} & {β}_{12} & … & {β}_{1 K} \\ {β}_{21} & {β}_{2} & … & {β}_{2 K} \\ ⋮ & ⋮ & ⋱ & ⋮ \\ {β}_{K 1} & {β}_{K 2} & … & {β}_{K}\end{matrix} ]$$

$$where :$$

$${β}_{k} = \frac{1}{\vert {C}_{k} \vert \vert {C}_{k} \vert} {\sum }_{( i , j ∈ E )} 1 ( {c}_{i} = {c}_{j} = k )$$

$${β}_{ij} = {β}_{ji} = \frac{1}{\vert {C}_{{k}_{1}} \vert \vert {C}_{{k}_{2}} \vert} {\sum }_{( i , j ∈ E )} 1 ( {c}_{i} = {k}_{1} and {c}_{j} = {k}_{2} )$$

where Cₖ is a count of the nodes of the graph that belong to community k. βᵢⱼ is a count of the number of cross-community edges from community i to community k (βᵢⱼ=βⱼᵢ may be true in the case where all edges in the graph are bidirectional edges), and βₖ is a count of the number of inner-community edges within community k. Since community k is formed by nodes that are assigned the class label yₖ, community k may also be referred to as a community of nodes having label yₖ.

The cross-community ratio matrix (denoted as S′) is computed by dividing each element in a given row by the sum of all elements in the given row. This may be expressed as:

$${S}^{′} = [ \begin{matrix}{β}_{1} / {\sum }_{j = 1}^{K} {β}_{1 j} & {β}_{12} / {\sum }_{j = 1}^{K} {β}_{1 j} & … & {β}_{1 K} / {\sum }_{j = 1}^{K} {β}_{1 j} \\ {β}_{21} / {\sum }_{j = 1}^{K} {β}_{2 j} & {β}_{2} / {\sum }_{j = 1}^{K} {β}_{2 j} & … & {β}_{2 K} / {\sum }_{j = 1}^{K} {β}_{2 j} \\ ⋮ & ⋮ & ⋱ & ⋮ \\ {β}_{K 1} / {\sum }_{j = 1}^{K} {β}_{Kj} & {β}_{K 2} / {\sum }_{j = 1}^{K} {β}_{Kj} & … & {β}_{K} / {\sum }_{j = 1}^{K} {β}_{Kj}\end{matrix} ]$$

The i-th row of the cross-community ratio matrix S′ contains the inner-community and cross-community ratios with respect to the community of nodes having class label yᵢ. The element in the j-th column of the i-th row is the cross-community ratio between the community of nodes having class label yᵢ and the community of nodes having class label yⱼ, where i≠j. The diagonal element in the i-th row (i.e., the element in the i-th column of the i-th row) of the cross-community ratio matrix S′ is the inner-community ratio for the community of nodes having class label yᵢ.

Each data triplet is constructed by selecting a respective node in the combined set of labeled nodes as an anchor node (i.e., each node in the combined set of labeled nodes is used as an anchor node for constructing a respective data triplet). A positive node is selected by selecting (e.g., at random) another node having the same label as the anchor node (i.e., the label assigned to the positive node represents the same class as the label assigned to the anchor node).

The present disclosure describes a hard negatives sampling technique in which a negative node is selected based on the cross-community ratio with respect to the community of nodes having the class label of the anchor node. Mathematically, the disclosed hard negatives sampling technique defines the probability that a given node vⱼ is selected as a negative node for an anchor node vᵢ as follows:

$$P ( {x}^{-} = {v}_{j} \vert S , x = {v}_{i} ) = \frac{{S}_{{y}_{i} , {y}_{j}}}{{\sum }_{\begin{matrix}k = 1 , \\ k \neq {y}_{i}\end{matrix}}^{C} {S}_{{y}_{i} , k}}$$

where the numerator S_{y}_{ᵢ}_{,y}_{ⱼ} is the cross-community strength value such that node vᵢ has class label yᵢ and node vⱼ has class label yⱼ, and the denominator is the sum of all cross-community strength values with respect to the class label yᵢ (excluding the inner-community strength value (i.e., k≠yᵢ)). The value of P(x⁻=vⱼ|S, x=vᵢ) corresponds to the element in the i-th row of the j-th column of the cross-community ratio matrix S′, which is the cross-community ratio between the community of nodes having class label yᵢ (which is the class label of the anchor node vᵢ) and the community of nodes having class label yⱼ.

Based on the computation of the cross-community ratio, the negative node for a given anchor node is selected by identifying the community of nodes having the class label that has the highest cross-community ratio with respect to the community of nodes having the class label of the given anchor node, and selecting the negative node from the identified community of nodes. The highest cross-community ratio indicates that the community to which the negative node belongs has the highest strength of cross-community connectivity with the community to which the anchor node belongs. In this way, a data triplet may be constructed using each node in the combined set of labeled nodes as an anchor node.

Reference is again made to FIG. 2. Constructing data triplets using hard negatives sampling based on the cross-community ratio, as described above, may enable more efficient training of the GNN. In some examples, operation 210 may be omitted, and data triplets may be constructed using any suitable existing technique (e.g., by random sampling).

At operation 212, the GNN is trained using the combined set of labeled nodes, to update the set of values for parameters of the GNN. The GNN is trained using a total loss that is a sum of the cross-entropy loss and supervised contrastive loss. The adjacency matrix and feature matrix of the combined set of labeled nodes are forward propagated through the GNN to generate a predicted label for each node in the combined set of labeled nodes. A total loss is computed between the predicted labels and the labels (either ground-truth label or pseudo label) assigned to the nodes. Specifically, the total loss is a sum of a cross-entropy loss and a supervised contrastive loss, as discussed above. A gradient of the total loss is then computed and a backpropagation algorithm is used to update the set of values for the parameters of the GNN. Defining a total loss in this manner enables the GNN to be trained using supervised contrastive learning that uses label information, unlike existing self-supervised contrastive learning approaches.

Operations 204-212 may be considered one training iteration. In each training iteration, the set of values for the parameters of the GNN are updated. It should be noted that pseudo labels that are assigned to nodes in a given training iteration are not fixed, and the pseudo labels generated in each training iteration may be discarded at the end of that training iteration (e.g., may be discarded following computation of the total loss). For example, a node that is assigned a given pseudo label (i.e., a label representing a given class) in one training iteration may be assigned a different pseudo label (i.e., a label representing a different class) in another training iteration, or may not be assigned any pseudo label (e.g., the predicted label generated by the GNN for that node is associated with a low confidence indicator) in another training iteration. However, it is expected that the GNN will generate more consistent predicted labels with higher confidence as the number of training iterations increases.

Operations 204-212 may be repeated until a convergence condition is satisfied (e.g., the values of the parameters of the GNN converge, the loss converges, the validation loss converges, a maximum number of training iterations has been performed, or some other accuracy metric is satisfied).

The method 200 proceeds to operation 214 when the convergence condition is satisfied.

At operation 214, the set of learned values for the parameters of the

GNN are stored. The GNN with the set of learned values for the parameters is a trained GNN that can be used to perform a node classification task. In some examples, if the training system (i.e., the computing system that performs the method 200) is different from the execution system (i.e., the computing system that executes the trained GNN), the set of learned values for the parameters may be communicated from the training system to the execution system and stored locally at the execution system. In some examples, the architecture of the GNN may also be communicated to the execution system.

In some examples, the pseudo labels generated in the final training iteration may be stored as labels for the corresponding nodes of the graph. The pseudo labels may be considered ground-truth labels for the corresponding nodes. In this way, the method 200 may enable automated annotation of the nodes of the graph.

The method 200 may be used to train a GNN to perform any type of node classification task, and may be useful in scenarios where data with ground-truth labels are scarce.

For example, the method 200 may be used to train a GNN to perform node classification of a social network graph. The GNN may be trained to predict a label for each node in the social network graph, where each node represents an individual and each label represents a category of interest (e.g., sports, music, comics, gaming, etc.). The feature vector for each node may represent features of the user profile of the individual, such as gender, location, historical interactions, etc. Each edge between two nodes represents a social connection between the two individuals represented by the two nodes (e.g., friends, colleagues, etc.). In such a scenario, there is usually a scarcity of ground-truth labeled nodes, for example because few individuals explicitly identify their category of interest in their user profile or because such ground-truth labels require time-consuming and/or costly manual annotation. Using the disclosed method 200, a GNN may be trained to predict a label representing the category of interest for each node with high confidence, despite the scarcity of training data.

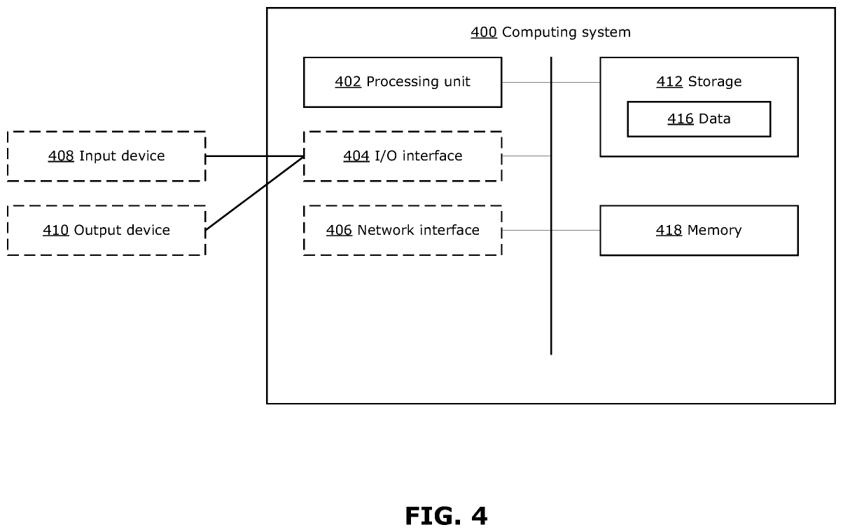

FIG. 4 is a block diagram illustrating a simplified example implementation of a computing system 400 suitable for implementing embodiments described herein. Examples of the present disclosure may be implemented in other computing systems, which may include components different from those discussed below. Although FIG. 4 shows a single instance of each component, there may be multiple instances of each component in the computing system 400. The computing system 400 may be a training system used to execute instructions for training a GNN, for example using the method 200. The computing system 400 may also be an execution system used to execute the trained GNN, or the GNN may be executed by another computing system.

Although FIG. 4 shows a single instance of each component, there may be multiple instances of each component in the computing system 400. Further, although the computing system 400 is illustrated as a single block, the computing system 400 may be a single physical machine or device (e.g., implemented as a single computing device, such as a single workstation, single consumer device, single server, etc.), or may comprise a plurality of physical machines or devices (e.g., implemented as a server cluster). For example, the computing system 400 may represent a group of servers or cloud computing platform providing a virtualized pool of computing resources (e.g., a virtual machine, a virtual server).

The computing system 400 includes at least one processing unit 402, such as a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 400 may include an optional input/output (I/O) interface 404, which may enable interfacing with an optional input device 408 and/or optional output device 410. In the example shown, the optional input device 408 (e.g., a keyboard, a mouse, a microphone, a touchscreen, and/or a keypad) and optional output device 410 (e.g., a display, a speaker and/or a printer) are shown as optional and external to the computing system 400. In other example embodiments, there may not be any input device 408 and output device 410, in which case the I/O interface 404 may not be needed.

The computing system 400 may include an optional network interface 406 for wired or wireless communication with other computing systems (e.g., other computing systems in a network). The network interface 406 may include wired links (e.g., Ethernet cable) and/or wireless links (e.g., one or more antennas) for intra-network and/or inter-network communications. For example, the network interface 406 may enable the computing system 400 to access data samples from an external database, or cloud-based data center (among other possibilities) where training datasets are stored. The network interface 406 may enable the computing system 400 to communicate learned values of the parameters of the GNN to another computing system (e.g., an edge computing device or other end consumer device) where the trained GNN is to be deployed for inference.

The computing system 400 may include a storage unit 412, which may include a mass storage unit such as a solid state drive, a hard disk drive, a magnetic disk drive and/or an optical disk drive. The storage unit 412 may store data 416, such as the architecture and learned values of the parameters of the GNN.

The computing system 400 may include a memory 418, which may include a volatile or non-volatile memory (e.g., a flash memory, a random access memory (RAM), and/or a read-only memory (ROM)). The non-transitory memory 418 may store instructions for execution by the processing unit 402, such as to carry out example embodiments described in the present disclosure. For example, the memory 418 may store instructions for implementing the disclosed method for training a GNN, and may also store instructions for executing the GNN. The memory 418 may include other software instructions, such as for implementing an operating system and other applications/functions.

The computing system 400 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The present disclosure helps to address the problem that there is typically a scarcity of graph data with ground-truth labeled nodes. In the methods and systems disclosed herein, labels predicted by the GNN with high confidence are used as pseudo labels. The pseudo labeled nodes may be added to the ground-truth labeled nodes, to train the GNN model using a semi-supervised approach. The use of pseudo labels helps to increase the amount of labeled data for training the GNN model, and may help to improve the performance of the trained GNN in a node classification task compared to that of a GNN that is trained using only ground-truth labeled nodes.

The disclosed technique for constructing data triplets using hard negatives sampling, based on the cross-community ratio, may enable the GNN to be trained in more efficiently (e.g., requiring fewer training iterations), compared to training using data triplets constructed by random sampling. The disclosed hard negatives sampling technique may also result in a trained GNN that has better performance (e.g., predicts node labels with higher accuracy), because the hard negatives sampling enables the GNN to learn the boundary in the embedding space between easily misclassified nodes.

Although the present disclosure describes methods and processes with operations in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for training a graph neural network (GNN) to perform a node classification task, the method comprising:
obtaining a set of pre-trained values for parameters of the GNN;
training the GNN by, in each training iteration:
inputting an adjacency matrix and a feature matrix of a set of unlabeled nodes of a graph to the GNN to obtain a predicted label for each node in the set of unlabeled nodes;
selecting one or more of the predicted labels as respective one or more pseudo labels, each predicted label that is selected as a pseudo label being associated with a confidence indicator that satisfies a high confidence criterion;
assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and
updating the values of the parameters of the GNN by:
forward propagating an adjacency matrix and a feature matrix of the combined set of labeled nodes to generate, using the GNN, a predicted label for each node in the combined set of labeled nodes;
computing a total loss between the predicted labels generated by the GNN for the combined set of labeled nodes and assigned labels of the combined set of labeled nodes, the total loss being computed as a sum of a computed cross-entropy loss and a computed supervised contrastive loss; and
backpropagating a gradient of the computed total loss to update the values of the parameters of the GNN;
repeating the training iterations until a convergence condition is satisfied; and
storing the updated values of the parameters of the GNN as learned values of the parameters of the GNN.

2. The method of claim 1, further comprising:
prior to computing the total loss, constructing data triplets for computing the supervised contrastive loss, each data triplet being constructed by:
selecting a first node in the combined set of labeled nodes as an anchor node of the data triplet;
selecting a second node in the combined set of labeled nodes as a positive node of the data triplet, the positive node and the anchor node having assigned labels representing a same class; and
selecting a third node in the combined set of labeled nodes as a negative node of the data triplet, the negative node and the anchor node having assigned labels representing different classes;
wherein the supervised contrastive loss is computed using the constructed data triplets.

3. The method of claim 2, wherein selecting the third node as the negative node comprises:
computing a cross-community ratio between a first community of nodes having assigned labels representing the same class as the anchor node and each other community of nodes in the combined set of labeled nodes; and
selecting the third node as the negative node based on the third node belonging to a second community of nodes having a highest cross-community ratio with the first community of nodes.

4. The method of claim 3, wherein the cross-community ratio computed between the third node and the anchor node represents a strength of cross-community connectivity between the first community of nodes and the second community of nodes.

5. The method of claim 1, wherein a predicted label that is selected as a pseudo label is associated with a softmax probability that satisfies the high confidence criterion.

6. The method of claim 1, further comprising obtaining the set of pre-trained values for the parameters of the GNN by:
training the GNN using the set of ground-truth labeled nodes and using computation of a cross-entropy loss.

7. The method of claim 1, further comprising:
storing the pseudo labels from a final training iteration as ground-truth labels of the graph.

8. A computing system for training a graph neural network (GNN) to perform a node classification task, the computing system comprising a processing unit and a memory storing instructions which, when executing by the processing unit, cause the computing system to:
obtain a set of pre-trained values for parameters of the GNN;
train the GNN by, in each training iteration:
inputting an adjacency matrix and a feature matrix of a set of unlabeled nodes of a graph to the GNN to obtain a predicted label for each node in the set of unlabeled nodes;
selecting one or more of the predicted labels as respective one or more pseudo labels, each predicted label that is selected as a pseudo label being associated with a confidence indicator that satisfies a high confidence criterion;
assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and
updating the values of the parameters of the GNN by:
forward propagating an adjacency matrix and a feature matrix of the combined set of labeled nodes to generate, using the GNN, a predicted label for each node in the combined set of labeled nodes;
computing a total loss between the predicted labels generated by the GNN for the combined set of labeled nodes and assigned labels of the combined set of labeled nodes, the total loss being computed as a sum of a computed cross-entropy loss and a computed supervised contrastive loss; and
backpropagating a gradient of the computed total loss to update the values of the parameters of the GNN;
repeat the training iterations until a convergence condition is satisfied; and
store the updated values of the parameters of the GNN as learned values of the parameters of the GNN.

9. The computing system of claim 8, wherein the instructions further cause the computing system to:
prior to computing the total loss, construct data triplets for computing the supervised contrastive loss, each data triplet being constructed by:
selecting a first node in the combined set of labeled nodes as an anchor node of the data triplet;
selecting a second node in the combined set of labeled nodes as a positive node of the data triplet, the positive node and the anchor node having assigned labels representing a same class; and
selecting a third node in the combined set of labeled nodes as a negative node of the data triplet, the negative node and the anchor node having assigned labels representing different classes;
wherein the supervised contrastive loss is computed using the constructed data triplets.

10. The computing system of claim 9, wherein the instructions cause the computing system to select the third node as the negative node by:
computing a cross-community ratio between a first community of nodes having assigned labels representing the same class as the anchor node and each other community of nodes in the combined set of labeled nodes; and
selecting the third node as the negative node based on the third node belonging to a second community of nodes having a highest cross-community ratio with the first community of nodes.

11. The computing system of claim 10, wherein the cross-community ratio computed between the third node and the anchor node represents a strength of cross-community connectivity between the first community of nodes and the second community of nodes.

12. The computing system of claim 8, wherein a predicted label that is selected as a pseudo label is associated with a softmax probability that satisfies the high confidence criterion.

13. The computing system of claim 8, wherein the instructions further cause the computing system to obtain the set of pre-trained values for the parameters of the GNN by:
training the GNN using the set of ground-truth labeled nodes and using computation of a cross-entropy loss.

14. The computing system of claim 8, wherein the instructions further cause the computing system to:
store the pseudo labels from a final training iteration as ground-truth labels of the graph.

15. A non-transitory computer readable medium for training a graph neural network (GNN) to perform a node classification task, the non-transitory computer readable medium having instructions encoded thereon, wherein the instructions, when executed by a processing unit of a computing system, cause the computing system to:
obtain a set of pre-trained values for parameters of the GNN;
train the GNN by, in each training iteration:
inputting an adjacency matrix and a feature matrix of a set of unlabeled nodes of a graph to the GNN to obtain a predicted label for each node in the set of unlabeled nodes;
selecting one or more of the predicted labels as respective one or more pseudo labels, each predicted label that is selected as a pseudo label being associated with a confidence indicator that satisfies a high confidence criterion;
assigning each pseudo label to a respective corresponding node, to obtain a set of pseudo labeled nodes, and combining the set of pseudo labeled nodes with a set of ground-truth labeled nodes of the graph having assigned ground-truth labels to obtain a combined set of labeled nodes; and
updating the values of the parameters of the GNN by:
forward propagating an adjacency matrix and a feature matrix of the combined set of labeled nodes to generate, using the GNN, a predicted label for each node in the combined set of labeled nodes;
computing a total loss between the predicted labels generated by the GNN for the combined set of labeled nodes and assigned labels of the combined set of labeled nodes, the total loss being computed as a sum of a computed cross-entropy loss and a computed supervised contrastive loss; and
backpropagating a gradient of the computed total loss to update the values of the parameters of the GNN;
repeat the training iterations until a convergence condition is satisfied; and
store the updated values of the parameters of the GNN as learned values of the parameters of the GNN.

16. The non-transitory computer readable medium of claim 15, wherein the instructions further cause the computing system to:
prior to computing the total loss, construct data triplets for computing the supervised contrastive loss, each data triplet being constructed by:
selecting a first node in the combined set of labeled nodes as an anchor node of the data triplet;
selecting a second node in the combined set of labeled nodes as a positive node of the data triplet, the positive node and the anchor node having assigned labels representing a same class; and
selecting a third node in the combined set of labeled nodes as a negative node of the data triplet, the negative node and the anchor node having assigned labels representing different classes;
wherein the supervised contrastive loss is computed using the constructed data triplets.

17. The non-transitory computer readable medium of claim 16, wherein the instructions cause the computing system to select the third node as the negative node by:
computing a cross-community ratio between a first community of nodes having assigned labels representing the same class as the anchor node and each other community of nodes in the combined set of labeled nodes; and
selecting the third node as the negative node based on the third node belonging to a second community of nodes having a highest cross-community ratio with the first community of nodes.

18. The non-transitory computer readable medium of claim 17, wherein the cross-community ratio computed between the third node and the anchor node represents a strength of cross-community connectivity between the first community of nodes and the second community of nodes.

19. The non-transitory computer readable medium of claim 15, wherein a predicted label that is selected as a pseudo label is associated with a softmax probability that satisfies the high confidence criterion.

20. The non-transitory computer readable medium of claim 15, wherein the instructions further cause the computing system to:
store the pseudo labels from a final training iteration as ground-truth labels of the graph.
